(19) United States
(12) Patent Application Publication
(10) Pub. No.: US 2018/0304580 A1
(43) Pub. Date: Oct. 25, 2018

(54) FIBER-METAL LAMINATE AND ITS MANUFACTURING METHOD

(71) Applicant: BYD COMPANY LIMITED, Shenzhen, Guangdong (CN)

(72) Inventors: Yangen MAO, Shenzhen (CN); Dingwen MAO, Shenzhen (CN); Pinshuang LAN, Shenzhen (CN)

(73) Assignee: BYD COMPANY LIMITED, Shenzhen, Guangdong (CN)

(21) Appl. No.: 15/523,893

(22) PCT Filed: Sep. 2, 2015
(86) PCT No.: PCT/CN2015/088888

§ 371 Date: May 2, 2017

(30) Foreign Application Priority Data
Nov. 24, 2014 (CN) 201410680802.1

(51) Int. Cl. B32B 7/08; B32B 27/12; B32B 3/08; B32B 5/02; B32B 15/08; B32B 37/06

(52) U.S. Cl. CPC B32B 7/08; B32B 27/12; B32B 3/08; B32B 15/18; B32B 15/08; B32B 37/06; B32B 5/02

(57) ABSTRACT

A fiber-metal laminate, includes fiber cloth; a resin layer, disposed on the fiber cloth; a metal layer, disposed on the resin layer; and a plurality of chopped fibers, distributed between the fiber cloth and the resin layer; wherein each chopped fiber includes a first part inserted into the fiber cloth and a second part fixed in the resin layer. A method of manufacturing the fiber-metal laminate is also provided.

### CROSS-REFERENCE TO RELATED APPLICATION

The present application claims a priority to and benefits of Chinese Patent Application No. 201410680802.1, filed with the State Intellectual Property Office (SIPO) of the People's Republic of China on Nov. 24, 2014, the entire content of which is hereby incorporated by reference.

### FIELD

Embodiments of the present disclosure generally relate to the field of manufacturing technology for a composite material with a fiber-metal laminate structure, and more particularly to a fiber-metal laminate and its manufacturing method.

### BACKGROUND

An aluminum alloy material has been widely applied in the aerospace industry since the early 1930s, for its advantages of low density, high intensity, high impact resistance, good machinability, and low costs. However, there are also some disadvantages which limit its further application, such as short fatigue life and poor corrosion resistance. A composite material including a glass fiber and a carbon fiber, which was invented since 1950, not only shows a high specific strength and a high specific stiffness, but also displays good fatigue performance and excellent corrosion resistance. However, such laminated composite material has poor lateral strength and low impact resistance, and is very easily to be delaminated from its interlayer junction surfaces. In order to solve some of the above disadvantages, a fiber-metal laminate was developed by Delft University of Technology using both a metal material and a fiber in the late 1970s.

The fiber-metal laminate is a new-type composite material having a hybrid and reinforced structure, typically represented by an aramid-aluminum laminate (i.e., ARALL) and a glass-reinforce aluminum (i.e., GLARE). The fiber-metal laminate and its manufacturing method, mechanics performance, advantages and potential application are disclosed in a reference document (Development of a New Hybrid Material Aramid-aluminum Laminate for Aircraft Structure, Vogelesang, L., Ind. Eng. Chem. Prod. Res. Dev., 1983, pp. 492-496) and US patent literatures (U.S. Pat. No. 5,039,571, U.S. Pat. No. 5,547,735 and U.S. Pat. No. 5,219,629). Currently, the glass-reinforce aluminum material has been widely used in the fuselage shell of aircraft 380, which is a significant innovation in the aircraft material technology.

The fiber-metal laminate, not only taking both advantages of the metal material and the fiber, but also overcoming most shortcomings thereof, is a structural material having immense application prospects in aerospace, military, automobile and other high-tech fields. Although the fiber-metal laminate shows such excellent performances mentioned above, the adhesion between the metal layer and the fiber cloth thereof is very poor.

### SUMMARY

An object of the present disclosure is to provide a fiber-metal laminate, so as to solve at least one problem existing in the related art, for example, a weak adhesion between the metal layer and the fiber cloth of the fiber-metal laminate.

Embodiments of one aspect the present disclosure provide a fiber-metal laminate. The fiber-metal laminate including: fiber cloth; a resin layer, disposed on the fiber cloth; a metal layer, disposed on the resin layer; and a plurality of chopped fibers, distributed between the fiber cloth and the resin layer, wherein each chopped fiber includes a first part inserted into the fiber cloth and a second part fixed in the resin layer.

In some embodiments, the chopped fiber is at least one selected from a group consisting of glass fiber, carbon fiber, and aramid fiber.

In some embodiments, the chopped fiber has a length of about 6 mm to about 30 mm, and has a cross-sectional diameter of about 10 μm to about 30 μm.

In some embodiments, the metal layer is one selected from a group consisting of aluminum alloy plate, titanium alloy plate, and steel plate; and the metal layer has a thickness of about 0.1 mm to about 2 mm.

In some embodiments, a surface of the metal layer towards the resin layer is provided with a plurality of micropores having an average diameter of about 15 μm to about 50 μm.

In some embodiments, the surface of the metal layer towards the resin layer is of an anodic oxide layer being in contact with the resin layer.

In some embodiments, the fiber cloth is at least one selected from a group consisting of glass fiber cloth, carbon fiber cloth, and aramid fiber cloth; and the fiber cloth has a thickness of about 0.1 mm to about 2 mm.

In some embodiments, the resin layer is at least one selected from a group consisting of acrylic layer, epoxy resin layer, and urethane resin layer, and the resin layer has a thickness of about 0.1 mm to about 2 mm.

In some embodiments, the metal layer includes a first metal layer and a second metal layer, and the resin layer includes a first resin layer and a second resin layer; wherein the second resin layer is disposed on the second metal layer, the fiber cloth is disposed on the second resin layer, the first resin layer is disposed on the fiber cloth, and the first metal layer is disposed on the first resin layer, the plurality of chopped fibers is distributed both between the second resin layer and the fiber cloth, and the fiber cloth and the first resin layer.

Embodiments of another aspect the present disclosure provide a method for manufacturing a fiber-metal laminate. The method includes steps of: providing a plurality of chopped fibers on a surface of the fiber cloth; inserting a first part of the chopped fiber into the surface of the fiber cloth; immersing fiber cloth inserted with the first part of the chopped fiber into a resin slurry to obtain immersed fiber cloth; overlaying a metal layer on the immersed fiber cloth; and hot pressing to obtain the fiber-metal laminate.

In some embodiments, the first part of the chopped fiber is inserted into the surface of the fiber cloth by needle-punching treatment.

In some embodiments, the needle-punching treatment is performed at a needle density of about 100 times/cm² to about 250 times/cm², and under a needle depth of about 0.1 mm to about 0.5 mm.

In some embodiments, the chopped fiber is at least one selected from a group consisting of glass fiber, carbon fiber, and aramid fiber, and the chopped fiber has a cross-sectional diameter of about 10 μm to about 30 μm, and has a length of about 6 mm to about 30 mm.

In some embodiments, the fiber cloth is at least one selected from a group consisting of glass fiber cloth, carbon fiber cloth, and aramid fiber cloth; and the fiber cloth has a thickness of about 0.1 mm to about 2 mm.

In some embodiments, the step of providing the plurality of chopped fibers on the surface of the fiber cloth is performed by steps of: placing the fiber cloth in an ethanol solution; adding the plurality of chopped fibers into the ethanol solution under an ultrasonic condition; depositing the plurality of chopped fibers on the surface of the fiber cloth; and drying the fiber cloth deposited with the plurality of chopped fibers.

In some embodiments, providing the plurality of chopped fibers on the surface of the fiber cloth includes: providing the plurality of chopped fibers on a first surface of the fiber cloth; and providing the plurality of chopped fibers on a second surface of the fiber cloth.

In some embodiments, the method includes steps of: immersing the first and second surfaces of the fiber cloth inserted with the first part of the chopped fiber into the resin slurry; overlaying a first metal layer on the first surface of the fiber cloth, and a second metal layer on the second surface of the fiber cloth; and hot pressing to obtain the fiber-metal laminate.

In some embodiments, the surface of the fiber cloth inserted with the first part of the chopped fiber is immersed into the resin slurry for about 10 minutes to about 60 minutes, to form a resin slurry layer with a thickness of about 0.1 mm to about 2 mm on the surface of the fiber cloth.

In some embodiments, the resin layer is at least one selected from a group consisting of acrylic resin layer, epoxy resin layer, and urethane resin layer.

In some embodiments, the metal layer is one selected from a group consisting of aluminum alloy plate, titanium alloy plate, and steel plate; and the metal layer has a thickness of about 0.1 mm to about 2 mm.

In some embodiments, the method further includes steps of: forming a plurality of micropores having an average diameter of about 15 μm to about 50 μm at a surface of the metal layer, and attaching the surface of the metal layer formed with the plurality of micropores with the surface of the immersed fiber cloth inserted with the first part of the chopped fiber.

In some embodiments, the plurality of micropores is formed by a chemical etching method, a laser pore-forming method, an arc pore-forming method or an electrochemical oxidation method.

In some embodiments, the step of hot pressing is performed at a temperature of about 140° C. to about 200° C. and at a pressure of about 0.1 MPa to about 20 MPa for about 10 minutes to about 30 minutes.

For the fiber-metal laminate according to embodiments of the present disclosure, the fiber cloth and the metal layer are bonded together by the resin layer. The plurality of chopped fibers is distributed between the resin layer and the fiber cloth, and each chopped fiber includes a first part inserted into the fiber cloth and a second part fixed in the first resin layer, so that the metal layer and the fiber cloth are bonded firmly with excellent adhesion.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic view showing a fiber-metal laminate according to an embodiment of the present disclosure; and

FIG. 2 is a schematic view showing a fiber-metal laminate according to another embodiment of the present disclosure.

### DETAILED DESCRIPTION

Reference will be made in detail to embodiments of the present disclosure. The embodiments described herein with reference to the accompany drawings are explanatory and illustrative, which are used to generally understand the present disclosure. The embodiments shall not be construed to limit the present disclosure.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items. It should be further understood that, when used in the specification, terms “including” and/or “containing” specify the presence of stated features, operations, elements and/or components, but do not exclude the presence or addition of one or more other features, operations, elements, components and/or groups thereof.

For the purpose of the present description and of the following claims, the definitions of the numerical ranges always include the extremes unless otherwise specified.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present invention, “a plurality of” means two or more than two, unless specified otherwise.

A fiber-metal laminate according to embodiments of the present disclosure will be discussed below in details.

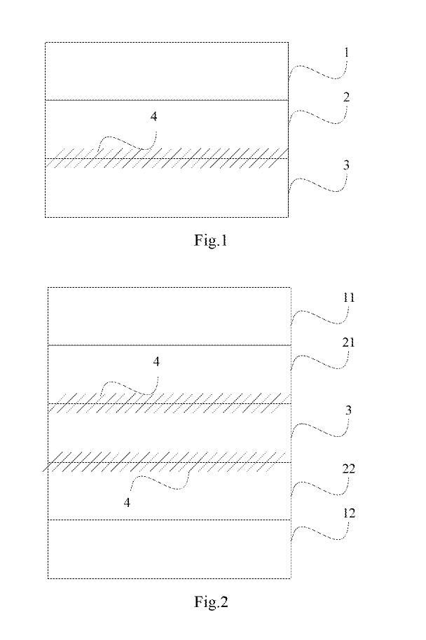

According to an embodiment of the present disclosure, referring to FIG. 1, the fiber-metal laminate includes: fiber cloth 3; a resin layer 2, disposed on the fiber cloth 3; a metal layer 1, disposed on the resin layer 2; and a plurality of chopped fibers 4, distributed between the fiber cloth 3 and the resin layer 2, wherein each chopped fiber 4 includes a first part inserted into the fiber cloth 3 and a second part fixed in the resin layer 2.

According to embodiments the present disclosure, the metal layer may be made of any conventional material or may be of any common structure in the art. In some embodiments, the metal layer is one selected from a group consisting of aluminum alloy plate, titanium alloy plate, and steel plate. In one embodiment, the metal layer is an aluminum alloy plate. The metal layer may be of a thickness without any special limitation, which may be adjusted in a wide range as practically required by those skilled in the art. In some embodiments, the metal layer has a thickness of about 0.1 mm to about 2 mm.

According to embodiments the present disclosure, in order to further improve the adhesion between the metal layer and the resin layer, a surface of the metal layer towards the resin layer is provided with a plurality of micropores. In some embodiments, each micropore has an average diameter of about 15 μm to about 50 μm, so as to improve the adhesion between the metal layer and the resin layer.

In some embodiments, in the case that the metal layer is the aluminum alloy plate, the surface of the metal layer towards the resin layer is of an anodic oxide layer being in contact with the resin layer. It would be appreciated by those skilled in the art that the anodic oxide layer (particularly an anodic oxide layer made of aluminium oxide) is of a loose and porous structure capable of providing higher adhesion between the metal layer and the resin layer. The anodic oxide layer (particularly an anodic oxide layer made of aluminium oxide) is made of ceramic, which has high rigidity, thereby further improve the adhesion between the metal layer and the resin layer.

According to embodiments of the present disclosure, the fiber cloth may be made of various conventional materials without any special limitation. In some embodiments, the fiber cloth is at least one selected from a group consisting of glass fiber cloth, carbon fiber cloth and aramid fiber cloth. In some other embodiments, the fiber cloth may be a blended fabric cloth made of at least one selected from a group consisting of glass fiber, carbon fiber, and aramid fiber.

In a specific example, as the glass fiber cloth has a thermal expansion coefficient similar to that of the metal layer, it is used as the fiber cloth, thereby further improve the adhesion between the metal layer and the resin layer under various environments.

According to embodiments of the present disclosure, the fiber cloth has an adjustable thickness in a wide range without any special limitation. In some embodiments, the fiber cloth has a thickness of about 0.1 mm to about 2 mm.

According to embodiments of the present disclosure, the resin layer is used to combine the metal layer and the fiber cloth into an integral structure. The resin layer may be obtained by curing; and made of any conventional resin in the art. In some embodiments, the resin layer is at least one selected from a group consisting of acrylic resin layer, epoxy resin layer, and urethane resin layer. In one embodiment, the resin layer is an epoxy resin layer. In some embodiments, the resin layer has a thickness of about 0.1 mm to about 2 mm.

According to embodiments of the present disclosure, a plurality of chopped fibers is distributed between the fiber cloth and the resin layer, and each chopped fiber includes a first part inserted into the fiber cloth and a second part fixed in the first resin layer. In other words, one end of the chopped fiber is inserted into the fiber cloth, and the other one end of the same chopped fiber is fixed in the resin layer. The first part inserted into the fiber cloth is connected to the second part fixed in the resin layer. It would be appreciated by those skilled in the art that the first part inserted into the fiber cloth is inevitably not connected to the second part fixed in the first resin layer due to a manufacturing process. In the present disclosure, the term “chopped fiber” used herein is defined as including both the first and second parts.

According to embodiments of the present disclosure, in order to improve the adhesion between every adjacent two layers of the fiber-metal laminate, the chopped fiber has a length of about 6 mm to about 30 mm.

According to embodiments of the present disclosure, the chopped fiber may be at least one selected from a group consisting of glass fiber, carbon fiber, and aramid fiber. The chopped fiber may have a cross-sectional diameter adjustable in a wide range. In some embodiments, the chopped fiber has a cross-sectional diameter of about 10 μm to about 30 μm.

It would be appreciated that the layer number of the fiber-metal laminate may be increased or decreased as practically required. In some embodiments, the metal layer includes a first metal layer and a second metal layer, and the resin layer includes a first resin layer and a second resin layer. Referring to FIG. 2, the second resin layer 22 is disposed on the second metal layer 12; the fiber cloth 3 is disposed on the second resin layer 22; the first resin layer 21 is disposed on the fiber cloth 3; the first metal layer 11 is disposed on the first resin layer 21; and the plurality of chopped fibers 4 is distributed both between the second resin layer 22 and the fiber cloth 3, and between the fiber cloth 3 and the first resin layer 21.

Embodiments of the present disclosure also provide a method for manufacturing a fiber-metal laminate. The method includes the following steps of: providing a plurality of chopped fibers on a surface of the fiber cloth; inserting a first part of the chopped fiber into the surface of the fiber cloth; immersing the surface of the fiber cloth inserted with the first part of the chopped fiber into a resin slurry to obtain immersed fiber cloth; overlaying a metal layer on the immersed fiber cloth; and hot pressing to obtain the fiber-metal laminate.

As mentioned above, the fiber cloth may be any conventional cloth in the art. In some embodiments, the fiber cloth is at least one selected from a group consisting of glass fiber cloth, carbon fiber cloth and aramid fiber cloth. In some other embodiments, the fiber cloth may be a blended fabric cloth made of at least one selected from a group consisting of glass fiber, carbon fiber, and aramid fiber.

In a specific example, as the glass fiber cloth has a thermal expansion coefficient similar to that of the metal layer, it is used as the fiber cloth, thereby further improve the adhesion between the metal layer and the resin layer under various environments.

According to embodiments of the present disclosure, the fiber cloth has an adjustable thickness in a wide range without any special limitation. In some embodiments, the fiber cloth has a thickness of about 0.1 mm to about 2 mm.

According to embodiments of the present disclosure, the chopped fiber is made of at least one selected from a group consisting of glass fiber, carbon fiber, and aramid fiber. In some embodiments, the chopped fiber has a length of about 6 mm to about 30 mm, and has a cross-sectional diameter of about 10 μm to about 30 μm, thereby improve the adhesion between every two adjacent layers of the fiber-metal laminate.

According to embodiments of the present disclosure, the plurality of chopped fibers is distributed on the surface of the fiber cloth uniformly, so that they can be inserted into the fiber cloth uniformly by the subsequent needle-punching treatment. According to embodiments of the present disclosure, the chopped fiber may be distributed on the surface of the fiber cloth by various conventional methods. In some embodiments, the plurality of chopped fibers may be directly distributed on the surface of the fiber cloth uniformly in air.

In order to distribute the plurality of chopped fibers more uniformly, the step of providing the plurality of chopped fibers on the surface of the fiber cloth is performed by steps of: placing the fiber cloth in an ethanol solution; adding the plurality of chopped fibers into the ethanol solution under an ultrasonic condition; depositing the plurality of chopped fibers on the surface of the fiber cloth; and drying the fiber cloth deposited with the plurality of chopped fibers. For the above steps, the ultrasonic condition may be provided by any conventional method in the art. In some embodiments, the ultrasonic condition may be of a frequency of about 5 KHz to about 50 KHz, which is not specially limited herein.

The plurality of chopped fibers may be distributed on the surface of the fiber cloth with an adjustable amount as practically required. In some embodiments, about 0.1 g to about 1 g of the chopped fiber is added for each square centimeter of the fiber cloth.

According to embodiments of the present disclosure, after the plurality of chopped fibers is provided on the surface of the fiber cloth, the first part of the chopped fiber is inserted into the fiber cloth by needle-punching treatment. In some embodiments, the needle-punching treatment is performed by a needle-punching machine, which is aligned above the fiber cloth in advance, at a needle density of about 100 times/cm² to about 250 times/cm², and a needle depth of about 0.1 mm to about 0.5 mm.

It would be appreciated that some chopped fibers are inserted into the fiber cloth with their first parts; others are not inserted therein inevitably, which needs to be removed thereafter. A removing method may include purging the surface of the fiber cloth with compressed air having a pressure of about 0.1 MPa to about 1 MPa.

According to embodiments of the present disclosure, in the case that both surfaces of the fiber cloth need to be bonded with two metal layers, respectively, the fiber cloth is inserted with the first part of chopped fiber at both surfaces by the needle-punching treatment. In specific, the plurality of chopped fibers is provided on a second surface of the fiber cloth inserted with the first part of chopped fiber at a first surface of the fiber cloth; and then the first part of chopped fiber is inserted into the second surface of the fiber cloth by the needle-punching treatment. In other words, the step of providing the plurality of chopped fibers on the surface of the fiber cloth includes: providing the plurality of chopped fibers on a first surface of the fiber cloth, and providing the plurality of chopped fibers on a second surface of the fiber cloth.

After above steps, fiber cloth inserted with the first part of the chopped fiber at both surfaces is obtained. Then the method includes steps of: immersing the first and second surfaces of the fiber cloth inserted with the first part of the chopped fiber into the resin slurry; overlaying a first metal layer on the first surface of the fiber cloth; and a second metal layer on the second surface of the fiber cloth; and hot pressing to obtain the fiber-metal laminate.

According to embodiments of the present disclosure, the resin slurry used in immersing the fiber cloth may be various resin solutions conventionally used in the art without any special limitation. In some embodiments, the fiber cloth inserted with the first part of the chopped fiber is immersed into the resin slurry for about 10 minutes to about 60 minutes, to form a resin slurry layer thereon. In some embodiments, the resin layer may be at least one selected from a group consisting of acrylic resin layer, epoxy resin layer, and urethane resin layer. In a specific example, the resin layer is an epoxy resin layer. In some embodiments, the resin slurry may be obtained by dissolving the resin in any conventionally-used solvent without any special limitation, such as chloroform.

In one embodiment, the resin slurry may include 100 weight parts of epoxy resin, such as E-51 epoxy resin; about 40 weight parts to about 60 weight parts of polysulfone resin; about 10 weight parts to about 20 weight parts of a curing agent, such as dicyandiamide; and about 300 weight parts to about 350 weight parts of a solvent, such as chloroform.

According to embodiments of the present disclosure, after the fiber cloth inserted with the first part of the chopped fiber is immersed into the resin slurry and moved out therefrom, a resin slurry layer is attached on the surface of the fiber cloth. The resin slurry layer may have a thickness without any special limitation. In some embodiments, the resin layer may have a thickness of about 0.1 mm to about 2 mm.

According to embodiments of the present disclosure, the second part of the chopped fiber, which is not inserted into and exposed outside the fiber cloth, is distributed in the resin slurry. As a result, after the resin slurry is cured, the second part of the chopped fiber exposed outside the fiber cloth is fixed inside the resin layer, thereby to obtain an integral structure. In the case that both surfaces of the fiber cloth are inserted with the first part of the chopped fiber, then the second part of the chopped fiber at each surface is fixed inside the resin layer after the above-mentioned immersing and curing steps.

According to embodiments of the present disclosure, after the immersing step, a metal layer is overlaid on immersed fiber cloth inserted with the first part of the chopped fiber, and then the resin is cured to integrate the fiber cloth and the metal layer through hot pressing, thereby to obtain the fiber-metal laminate. It would be appreciated that the surface of the fiber cloth inserted with the first part of the chopped fiber should be placed towards the metal layer, so that the resin layer may be in contact with the metal layer after the hot pressing step.

The metal layer may be any conventional metal layer. In some embodiments, the metal layer is one of aluminum alloy plate, titanium alloy plate, and steel plate. The metal layer may have a thickness adjustable in a wide range as practically required. In some embodiments, the metal layer has a thickness of about 0.1 mm to about 2 mm.

In order to further improve the adhesion between every adjacent two layers of the fiber-metal laminate, the method further includes steps of:

forming a plurality of micropores having an average diameter of about 15 μm to about 50 μm at a surface of the metal layer, and

attaching the surface of the metal layer formed with the plurality of micropores with the surface of the immersed fiber cloth inserted with the first part of the chopped fiber.

According to embodiments of the present disclosure, the plurality of micropores may be formed by various conventional methods in the art. In some embodiments, the plurality of micropores is formed by a chemical etching method, a laser pore-forming method, an arc pore-forming method, or an electrochemical oxidation method.

In some embodiments, in the case that an aluminum alloy plate is used as the metal layer, a plurality of micropores is formed at the surface of the metal layer is performed by an anodizing method well-known to those skilled in the art, thus so as to obtain an anodic oxidation layer on the surface of the metal layer. The step of anodizing is well known to the skilled in the art. In specific: the metal layer is placed in an electrolyte solution: the metal layer is used as an anode; a conductive material which may not react with the electrolyte solution is used as a cathode; the anode and the cathode are electrically connected with the negative electrode and the positive electrode of a power, respectively; after turning on the power, an anodic oxidation layer is formed on the metal layer. The electrolyte solution may be a sulfuric acid solution with a concentration of about 100 g/L to about 250 g/L. The anodizing method is performed at a temperature of about 20° C. to about 30° C. and under a voltage of about 10 V to about 20 V for about 10 minutes to about 30 minutes.

In some embodiments, the laser pore-forming method is performed by a pulse optical fiber laser with a wavelength of about 1.7 μm under the following conditions: a pulse repetition frequency of about 1000 Hz to about 5000 Hz, a pore pitch of about 0.01 mm to about 0.2 mm, a scanning speed of about 5000 mm/s to about 12000 mm/s, and a drilling speed of about 10 ms to about 30 ms.

According to embodiments of the present disclosure, after above steps, the step of hot pressing may be performed.

The hot pressing may be performed by any method conventionally-used in the art. In some embodiments, the hot pressing is performed at a temperature of about 140° C. to about 200° C. and at a pressure of about 0.1 MPa to about 20 MPa for about 10 minutes to about 30 minutes followed by steps of cooling and pressure relief, so that the fiber-metal laminate is obtained.

The present disclosure will be described in details below with reference to the following embodiments.

### Embodiment 1

The present embodiment provides a fiber-metal laminate and its manufacturing method. The method includes the following steps.

(1) Preparation:

Glass fiber cloth having a thickness of 0.4 mm and an area of 200 mm×200 mm was taken as fiber cloth. An aluminum alloy 6061 having a thickness of 0.4 mm was taken as a metal layer. A glass fiber having a length of 15 mm and a cross-sectional diameter of 14 μm was taken as a chopped fiber. (2) The fiber cloth was placed in an ethanol solution flatly. 100 g of the chopped fibers was added into the ethanol solution under an ultrasonic condition having a frequency of 25 KHz. Then the fiber cloth was taken out and dried in air after the chopped fibers deposited on the surface of the fiber cloth.

(3) The chopped fibers deposited on the surface of the fiber cloth were inserted into the fiber cloth at their first part by needle-punching treatment with a needle-punching machine at a needle density of 200 times/cm² and a needle depth of 0.3 mm. Those chopped fiber, which are not inserted into the fiber cloth at their first parts, were removed and purged with air under a pressure of 0.2 MPa.

(4) The fiber cloth inserted with the first part of the chopped fiber, which was obtained in step (3), was immersed into a resin slurry (including: 100 weight parts of E-51 epoxy resin, 50 weight parts of polysulfone resin, 12 weight parts of dicyandiamide as a curing agent, and 320 weight parts of chloroform as a solvent) for 30 minutes, so as to form a resin layer having a thickness of 0.2 mm on the surface of the fiber cloth.

(5) In an anodizing bath, 200 g/L of sulfuric acid serving as an electrolyte solution, the metal layer was electrolyzed under a voltage of 15 V and at a temperature of 25° C. for 22 minutes by means of taking a graphite carbon plate as a cathode and the metal layer as an anode, so as to form an anodic oxidation layer on the surface of the metal layer. The anodic oxidation layer was provided with a plurality of micropores each having an average diameter of 15 μm to 50 μm.

(6) Two metal layers with the plurality micropores obtained in step (5) and immersed fiber cloth inserted with the first part of the chopped fiber at both surfaces obtained in step (4) were overlaid together according to an order: metal layer-fiber cloth-metal layer, enabling the anodic oxidation layer of the metal layer to be in contact with the resin layer on the surface of the fiber cloth inserted with the first part of the chopped fiber. Then the resin layer was cured to integrate the metal layer and the fiber cloth by hot pressing under a pressure of 2 MPa and at a temperature of 165° C. for 20 minutes. After steps of cooling and pressure relief, a fiber-metal laminate denoted S1 was obtained.

### Embodiment 2

The present embodiment provides a fiber-metal laminate manufactured by a method similar to that in EMBODIMENT 1 with exceptions below:

step (1), the metal layer had a thickness of 0.2 mm;

step (6), three metal layers with the plurality micropores obtained in step (5) and two immersed fiber clothes inserted with the first part of the chopped fiber at both surfaces obtained in step (4) were overlaid together according to an order: metal layer-fiber cloth-metal layer-fiber cloth-metal layer.

A fiber-metal laminate denoted S2 was obtained.

### Embodiment 3

The present embodiment provides a fiber-metal laminate manufactured by a method similar to that in EMBODIMENT 1 with exceptions below:

step (5), the plurality of micropores was formed by a laser pore-forming method, instead of the anodic oxidation method. The laser pore-forming method was performed by a pulse optical fiber laser with a wavelength of about 1.7 μm under the following conditions: a pulse repetition frequency of about 2200 Hz, a pore pitch of about 0.05 mm, a scanning speed of 10000 mm/s, and a drilling speed of about 12 ms, thereby to obtain the plurality of micropores each having an average diameter of 15 μm to 50 μm.

A fiber-metal laminate denoted S3 was obtained.

### Embodiment 4

The present embodiment provides a fiber-metal laminate and its manufacturing method. The method includes the following steps.

(1) Preparation:

Carbon fiber cloth having a thickness of 1.8 mm and an area of 200 mm×200 mm was taken as fiber cloth. An aluminum alloy 6061 having a thickness of 1.2 mm was taken as a metal layer. A glass fiber having a length of 6 mm and a cross-sectional diameter of 26 μm was taken as a chopped fiber. (2) The fiber cloth was placed in an ethanol solution flatly. 100 g of the chopped fibers was added into the ethanol solution under an ultrasonic condition having a frequency of 25 KHz. Then the fiber cloth was taken out and dried in air after the chopped fibers deposited on the surface of the fiber cloth.

(3) The chopped fibers deposited on the surface of the fiber cloth were inserted into the fiber cloth at their first part by needle-punching treatment with a needle-punching machine at a needle density of 120 times/cm² and a needle depth of 0.5 mm. Those chopped fiber, which are not inserted into the fiber cloth at their first parts, were removed and purged with air under a pressure of 0.2 MPa. (4) The fiber cloth inserted with the first part of the chopped fiber, which was obtained in step (3), was immersed into a resin slurry (including 100 weight parts of E-51 epoxy resin, 50 weight parts of polysulfone resin, 12 weight parts of dicyandiamide as a curing agent, and 320 weight parts of chloroform as a solvent) for 30 minutes, so as to form a resin layer having a thickness of 1.8 mm on the surface of the fiber cloth.

(5) In an anodizing bath, 200 g/L of sulfuric acid serving as an electrolyte solution, the metal layer was electrolyzed under a voltage of 15 V and at a temperature of 25° C. for 22 minutes by means of taking a graphite carbon plate as a cathode and the metal layer as an anode, so as to form an anodic oxidation layer on the surface of the metal layer. The anodic oxidation layer was provided with a plurality of micropores each having an average diameter of 15 μm to 50 μm.

(6) Two metal layers with the plurality micropores obtained in step (5) and immersed fiber cloth inserted with the first part of the chopped fiber at both surfaces obtained in step (4) were overlaid together according to an order: metal layer-fiber cloth-metal layer, enabling the anodic oxidation layer of the metal layer to be in contact with the resin layer on the surface of the fiber cloth inserted with the first part of the chopped fiber. Then the resin layer was cured to integrate the metal layer and the fiber cloth by hot pressing under a pressure of 2 MPa and at a temperature of 165° C. for 20 minutes. After steps of cooling and pressure relief, a fiber-metal laminate denoted S1 was obtained.

### Embodiment 5

The present embodiment provides a fiber-metal laminate and its manufacturing method. The method includes the following steps.

(1) Preparation:

Aramid fiber cloth having a thickness of 0.1 mm and an area of 200 mm×200 mm was taken as fiber cloth. A titanium alloy having a thickness of 2 mm was taken as a metal layer. A carbon fiber having a length of 30 mm and a cross-sectional diameter of 20 μm was taken as a chopped fiber.

(2) The fiber cloth was placed in an ethanol solution flatly. 120 g of the chopped fibers was added into the ethanol solution under an ultrasonic condition having a frequency of 30 KHz. Then the fiber cloth was taken out and dried in air after the chopped fibers deposited on the surface of the fiber cloth.

(3) The chopped fibers deposited on the surface of the fiber cloth were inserted into the fiber cloth at their first part by needle-punching treatment with a needle-punching machine at a needle density of 240 times/cm² and a needle depth of 0.1 mm. Those chopped fiber, which are not inserted into the fiber cloth at their first parts, were removed and purged with air under a pressure of 0.2 MPa.

(4) The fiber cloth inserted with the first part of the chopped fiber, which was obtained in step (3), was immersed into a resin slurry (including 100 weight parts of E-51 epoxy resin, 50 weight parts of polysulfone resin, 12 weight parts of dicyandiamide as a curing agent, and 320 weight parts of chloroform as a solvent) for 30 minutes, so as to form a resin layer having a thickness of 1 mm on the surface of the fiber cloth.

(5) A plurality of micropores was formed by a laser pore-forming method. The laser pore-forming method was performed by a pulse optical fiber laser with a wavelength of about 1.7 μm under the following conditions: a pulse repetition frequency of about 2200 Hz, a pore pitch of about 0.05 mm, a scanning speed of 10000 mm/s, and a drilling speed of about 12 ms, thereby to obtain the plurality of micropores each having an average diameter of 15 μm to 50 μm.

(6) Two metal layers with the plurality micropores obtained in step (5) and immersed fiber cloth inserted with the first part of the chopped fiber at both surfaces obtained in step (4) were overlaid together according to an order: metal layer-fiber cloth-metal layer, enabling the anodic oxidation layer of the metal layer to be in contact with the resin layer on the surface of the fiber cloth inserted with the first part of the chopped fiber. Then the resin layer was cured to integrate the metal layer and the fiber cloth by hot pressing under a pressure of 2 MPa and at a temperature of 165° C. for 20 minutes. After steps of cooling and pressure relief, a fiber-metal laminate denoted S5 was obtained.

### Comparative Embodiment 1

The present comparative embodiment provides a fiber-metal laminate and its manufacturing method. The method includes the following steps.

(1) Preparation:

Glass fiber cloth having a thickness of 0.4 mm and an area of 200 mm×200 mm was taken as fiber cloth. An aluminum alloy 6061 having a thickness of 0.4 mm was taken as a metal layer.

(2) The fiber cloth was immersed into a resin slurry (including 100 weight parts of 51 epoxy resin, 50 weight parts of polysulfone resin, 12 weight parts of dicyandiamide as a curing agent, and 320 weight parts of chloroform as a solvent) for 30 minutes, so as to form a resin layer having a thickness of 0.2 mm on the surface of the fiber cloth.

(3) In an anodizing bath, 200 g/L of sulfuric acid serving as an electrolyte solution, the metal layer was electrolyzed under a voltage of 15 V and at a temperature of 25° C. for 22 minutes by means of taking a graphite carbon plate as a cathode and the metal layer as an anode, so as to form an anodic oxidation layer on the surface of the metal layer. The anodic oxidation layer was provided with a plurality of micropores each having an average diameter of 15 μm to 50 μm.

(6) Two metal layers with the plurality micropores obtained in step (3) and immersed fiber cloth obtained in step (2) were overlaid together according to an order: metal layer-fiber cloth-metal layer, enabling the anodic oxidation layer of the metal layer to be in contact with the resin layer on the surface of the fiber cloth. Then the resin layer was cured to integrate the metal layer and the fiber cloth by hot pressing under a pressure of 2 MPa and at a temperature of 165° C. for 20 minutes. After steps of cooling and pressure relief, a fiber-metal laminate denoted D1 was obtained.

Performance Tests

(1) The tensile strength of the fiber-metal laminates denoted S1-S5 and D1 were tested according to GBIT 228.1-2010, respectively.

(2) The bending strength of the fiber-metal laminates denoted S1-S5 and D1 were tested according to YB/T 5349-2006, respectively.

Obtained results were shown in Table 1.

TABLE 1

| | Tensile strength (MPa) | Bending strength (MPa) |
|---|---|---|
| S1 | 625 | 920 |
| S2 | 642 | 931 |
| S3 | 631 | 921 |
| S4 | 639 | 952 |
| S5 | 612 | 935 |
| D1 | 530 | 760 |

As can be seen from Table 1, as compared with the fiber-metal laminate in the related art, the fiber-metal laminates manufactured by the method according to embodiments of the present disclosure, each has higher tensile strength and bending strength, which demonstrates that the fiber-metal laminates manufactured by the method according to embodiments of the present disclosure have a strong adhesion between every adjacent two layers of the fiber-metal laminate.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications all falling into the scope of the claims and their equivalents may be made in the embodiments without departing from spirit and principles of the disclosure.

1. A fiber-metal laminate, comprising:
fiber cloth;
a resin layer, disposed on the fiber cloth;
a metal layer, disposed on the resin layer; and
a plurality of chopped fibers, distributed between the fiber cloth and the resin layer,
wherein each chopped fiber comprises a first part inserted into the fiber cloth and a second part fixed in the resin layer.

2. The fiber-metal laminate of claim 1, wherein the chopped fiber is selected from a group consisting of glass fiber, carbon fiber, aramid fiber and combination thereof.

3. The fiber-metal laminate of claim 1, wherein the chopped fiber has a length of 6 mm to 30 mm, and has a cross-sectional diameter of 10 μm to 30 μm.

4. The fiber-metal laminate of claim 1, wherein the metal layer is one selected from a group consisting of aluminum alloy plate, titanium alloy plate, and steel plate; and the metal layer has a thickness of 0.1 mm to 2 mm.

5. The fiber-metal laminate of claim 1, wherein a surface of the metal layer towards the resin layer is provided with a plurality of micropores having an average diameter of 15 μm to 50 μm.

6. The fiber-metal laminate of claim 5, wherein the surface of the metal layer towards the resin layer is of an anodic oxide layer being in contact with the resin layer.

7. The fiber-metal laminate of claim 1, wherein the fiber cloth is selected from a group consisting of glass fiber cloth, carbon fiber cloth, aramid fiber cloth, and combination thereof; and the fiber cloth has a thickness of 0.1 mm to 2 mm.

8. The fiber-metal laminate of claim 1, wherein the resin layer is selected from a group consisting of acrylic resin layer, epoxy resin layer, urethane resin layer and combination thereof; and the resin layer has a thickness of 0.1 mm to 2 mm.

9. The fiber-metal laminate of claim 1, wherein the metal layer comprises a first metal layer and a second metal layer, and the resin layer comprises a first resin layer and a second resin layer;
wherein the second resin layer is disposed on the second metal layer;
the fiber cloth is disposed on the second resin layer;
the first resin layer is disposed on the fiber cloth;
the first metal layer is disposed on the first resin layer; and
the plurality of chopped fibers is distributed both between the second resin layer and the fiber cloth, and between the fiber cloth and the first resin layer.

10. A method for manufacturing a fiber-metal laminate of claim 1, comprising steps of:
providing a plurality of chopped fibers on a surface of the fiber cloth;
inserting a first part of the chopped fiber into the surface of the fiber cloth;
immersing the surface of the fiber cloth inserted with the first part of the chopped fiber into a resin slurry to obtain immersed fiber cloth;
overlaying a metal layer on the immersed fiber cloth; and
hot pressing to obtain the fiber-metal laminate.

11. The method of claim 10, wherein the first part of the chopped fiber is inserted into the surface of the fiber cloth by needle-punching treatment.

12. The method of claim 11, wherein the needle-punching treatment is performed at a needle density of 100 times/cm² to 250 times/cm², and a needle depth of 0.1 mm to 0.5 mm.

13-14. (canceled)

15. The method of claim 10, wherein the step of providing the plurality of chopped fibers on the surface of the fiber cloth is performed by steps of:
placing the fiber cloth in an ethanol solution;
adding the plurality of chopped fibers into the ethanol solution under an ultrasonic condition;
depositing the plurality of chopped fibers on the surface of the fiber cloth; and
drying the fiber cloth deposited with the plurality of chopped fibers.

16. The method of claim 15, wherein 0.1 g to 1 g of the chopped fiber is added for each square centimeter of the fiber cloth.

17. The method of claim 10, wherein the step of providing the plurality of chopped fibers on the surface of the fiber cloth comprises:
providing the plurality of chopped fibers on a first surface of the fiber cloth; and
providing the plurality of chopped fibers on a second surface of the fiber cloth.

18. The method of claim 17, wherein the method comprises steps of:
immersing the first and second surfaces of the fiber cloth inserted with the first part of the chopped fiber into the resin slurry;
overlaying a first metal layer on the first surface of the fiber cloth, and a second metal layer on the second surface of the fiber cloth; and
hot pressing to obtain the fiber-metal laminate.

19. The method of claim 10, wherein the surface of the fiber cloth inserted with the first part of the chopped fiber is immersed into the resin slurry for 10 minutes to 60 minutes, to form a resin slurry layer with a thickness of 0.1 mm to 2 mm on the surface of the fiber cloth.

20-21. (canceled)

22. The method of claim 10 further comprising steps of:
forming a plurality of micropores having an average diameter of 15 μm to 50 μm at a surface of the metal layer, and
attaching the surface of the metal layer formed with the plurality of micropores with the surface of the immersed fiber cloth inserted with the first part of the chopped fiber.

23. The method of claim 22, wherein the plurality of micropores is formed by a chemical etching method, a laser pore-forming method, an arc pore-forming method, or an electrochemical oxidation method.

24. The method of claim 10, wherein the step of hot pressing is performed at a temperature of 140° C. to 200° C. and a pressure of 0.1 MPa to 20 MPa for 10 minutes to 30 minutes.
